(19) United States
(12) Patent Application Publication
(10) Pub. No.: US 2008/0007687 A1
(43) Pub. Date: Jan. 10, 2008

(54) Liquid crystal display device and a manufacturing method thereof

(75) Inventor: Takayuki Konno, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kanagawa (JP)

(21) Appl. No.: 11/808,858

(22) Filed: Jun. 13, 2007

(30) Foreign Application Priority Data
Jun. 15, 2006 (JP) 165592/2006

(51) Int. Cl. G02F 1/1339; G02F 1/1343

(52) U.S. Cl. 349/156; 349/141

(57) ABSTRACT

Disclosed is an active matrix liquid crystal display device, including a first substrate, a second substrate opposed to the first substrate and a liquid crystal layer sandwiched between the first and the second substrates. The first substrate includes: a scan signal line; a common signal line; an image signal line; a thin film transistor; a pixel electrode connected to the thin film transistor; a common electrode connected to the common signal line; an insulating film sandwiched between the lines and the electrodes; and a concave portion. The second substrate includes: the column-shaped spacers projecting to the first substrate and being almost equal in height to each other. A gap is formed between the first substrate and a tip of the column-shaped spacer at a position corresponding to the concave portion. The column-shaped spacer located at a different position reaches the first substrate.

### BACKGROUND OF THE INVENTION

1. Field of the Invention

The present application relates to a liquid crystal display device and its manufacturing method, and particularly to an In-Plane Switching (IPS) active matrix liquid crystal display device and its manufacturing method, the active matrix liquid crystal having wide aperture ratio and clear contrast.

2. Description of the Related Art

In recent years, adoption of an IPS (In-Plane Switching) method to a large-sized monitor of television set becomes prevailing. The IPS method enables to display an image through rotating a molecular axis of a liquid crystal in a plane parallel to a substrate by applying a horizontal electric field. Since a viewing angle according to the IPS method has no dependence on a rising angle of a molecular axis, the IPS method is more profitable substantially more than a TN (Twisted Nematic) method in regard to the viewing angle characteristics. However, IPS method needs an in-plane uniformity of higher precision cell gap than the TN method.

Then, a cell gap means a distance between two opposite substrates between which a liquid crystal layer is interposed.

In a conventional method to arrange a plurality of spherical spacers to form the cell gap, the plurality of spherical spacers do not fix on the substrate and moves in a liquid crystal display panel. Therefore, the precision of the in-plane uniformity of the liquid crystal display panel is limited. When the plurality of spherical spacers is arranged in the display area, the spherical spacers disturb orientation of the liquid crystal molecules around the spacer. The disturbed orientation causes light leak for a black state. In recent years, since request for clear contrast display of television set or medical machines becomes strong, the method using the plurality of spherical spacers is not preferable. Thus, a method to form a column-shaped spacer to an opposite substrate becomes indispensable for a large-sized product class in particular.

The column-shaped spacers are periodically arranged and have contact with the substrate on a side having TFT (Thin Film Transistor) at positions on lines or the like outside the display region, to keep a gap between the TFT substrate and an opposite substrate. The larger the number of column-shaped spacers becomes, the wider the contacting area becomes and the more uniform the gap becomes. A temporary slippage between the two substrates occurs, in case that external force is applied to one of the substrates in a direction parallel to the substrate surface. When the number of column-shaped spacers is large, the area where the column-shaped spacers have contact with the TFT substrate is also large. When the number is excessively large, frictional force between the plurality of the column-shaped spacers and the TFT substrate is strong, then the slipped substrate do not return to initial positions. On the other hand, in case that the number of the column-shaped spacers is excessively small, the substrate may be caused plastic deformation by an external force vertical to the substrate. When the plastic deformation occurs, the gap having local non-uniformity remains even if the external force disappears. In order to solve such problems, there is a method disclosed in Japanese Patent Gazette No. 3680730. Hereinafter, the method will be described with reference to drawings.

FIGS. 16A and 16B show that a column-shaped spacer has contact with a substrate at a position where a scan signal line 1601 is located. FIG. 16A indicates a structure of an auxiliary column in a normal state. A base pattern 1615 is formed at a predetermined position on the scan signal line 1601 through a gate insulation film 1603. The base pattern 1615 is not formed at other position. According to the structure, in case that an external force is not applied, only the column-shaped spacers 1617 (main column, hereinafter), which are opposed to the base pattern 1615, have contact with a TFT substrate 1618, to keep a gap between two substrates. According to a height difference which is equal to a thickness of the base pattern, the column-shaped spacer 1617 (auxiliary column, hereinafter), which is opposed to the substrate at the position where no base pattern is formed, does not have contact with the TFT substrate 1618. FIG. 16B shows a structure of the auxiliary column in case that an external force vertical to the substrate is applied thereto. The vertical external force causes a plastic deformation in the substrate. At this time, the auxiliary columns have contact with the TFT substrate and receive the external force in a dispersive manner. Since a contact area where the column-shaped spacers have contact with the TFT substrate is small, the problem caused by the external force parallel to the substrate hardly occurs.

FIGS. 17 and 18 show an example of an actual pixel structure. FIG. 17 is a plan view showing a structure of a pixel of the TFT substrate according to the conventional liquid crystal display device. FIG. 18 is a cross sectional view of the pixel taking along the dashed lines in FIG. 17.

As shown in FIG. 18, a scan signal line 1801 and a common signal line 1802 parallel to the scan signal line 1801, which are made of a first metal layer, are formed on a TFT substrate 1818. A gate insulation film 1803 is formed on the scan signal line 1801 and the common signal line 1802. An image signal line 1804, a thin film transistor 1805, a source electrode 1806 and a base pattern 1815, which are made of a second metal layer, are formed on the gate insulation film 1803. A passivation film 1807 is formed on the image signal line 1804, the thin film transistor 1805, the source electrode 1806 and the base pattern 1815. An overcoat film 1808 having photosensitivity is applied on the passivation film 1807.

The overcoat film 1808 is a transparent film made of acrylic resin, for example. Parts of the overcoat film 1808 which correspond to positions of a contact hole 1811 between a pixel electrode 1809 and the source electrode 1806, a contact hole 1812 between a common electrode 1810 and the common signal line 1802, and a hole 1816 in which the column-shaped spacer is fitted are removed by exposure. Furthermore, the substrate is etched, and consequently, the gate insulation film 1803 and the passivation film 1807 are removed. By the above mentioned processes, the contact hole 1811 between the pixel electrode and the source electrode and the contact hole 1812 between the common electrode and the common signal line are formed.

Next, the pixel electrode 1809 and the common electrode 1810 which are transparent electrodes are formed on the overcoat film 1808. At this time, the common electrode 1810 is formed also on the image signal line 1804 to shield electric field. The pixel electrode 1809 is electrically connected with the source electrode 1806 via the contact hole 1811. The common electrode 1810 is electrically connected with the common signal line 1802 via the contact hole 1812.

According to the structure, in case that an external force is not applied, the column-shaped spacer 1817 at the position of the main column has contact with the TFT substrate on the base pattern 1815. In contrast, the column-shaped spacer 1817 at the position of the auxiliary column does not have contact with the TFT substrate the base pattern 1815 is not formed. However, since the base pattern is an electrode of floating type, capacitive coupling between the base pattern and the scan signal line and short circuit of the base pattern with other electrode such as the image signal line cause adverse effect on the signal transfer. Accordingly, it is preferable that the step (i.e. height difference) is formed without the metal base pattern.

### SUMMARY OF THE INVENTION

The present application has been made in consideration of the above-mentioned problem. The main object of the application is to provide the liquid crystal display device with the step in which no capacitive coupling between the column-shaped spacer and the line and no short circuit of the column-shaped spacer with other electrodes occurs, and also is to provide the manufacturing method thereof.

A first exemplary aspect of the invention provides an active matrix liquid crystal display device, which includes a first substrate, a second substrate opposed to the first substrate and a liquid crystal layer sandwiched between the first substrate and the second substrate. The first substrate includes: a scan signal line; a common signal line being parallel to the scan signal line; an image signal line intersecting with the scan signal line and the common signal line; a thin film transistor formed at an intersection point of the scan signal line and the image signal line; a pixel electrode connected to one of electrodes of the thin film transistor; a common electrode connected to the common signal line; an insulating film sandwiched between at least one of the scan signal line, the common signal line and the image signal line, and at least one of the pixel electrode and the common electrode; and a first concave portion formed on a surface of the first substrate on a side where the thin film transistor is formed. The second substrate includes: a plurality of column-shaped spacers projecting to the first substrate and being almost equal in height to each other, a gap being formed between the first substrate and a tip of the column-shaped spacer located at a position corresponding to the first concave portion, and the column-shaped spacer located at a different position from the position corresponding to the first concave portion reaching the first substrate.

A second exemplary aspect of the invention provides an active matrix liquid crystal display device, which includes a first substrate, a second substrate opposed to the first substrate and a liquid crystal layer sandwiched between the first substrate and the second substrate. The first substrate includes: a scan signal line; a common signal line being parallel to the scan signal line; an image signal line intersecting with the scan signal line and the common signal line; a thin film transistor formed at an intersection point of the scan signal line and the image signal line; a pixel electrode connected to one of electrodes of the thin film transistor; a common electrode connected to the common signal line; an insulating film sandwiched between at least one of the scan signal line, the common signal line and the image signal line, and at least one of the pixel electrode and the common electrode; and a base formed on a surface of the first substrate on a side where the thin film transistor is formed, the base being formed by leaving the insulating film. The second substrate includes a plurality of column-shaped spacers projecting to the first substrate and being almost equal in height to each other. The column-shaped spacer located at a position corresponds to the base reaching the first substrate. A gap is formed between the first substrate and a tip of the column-shaped spacer located at a position different from the position corresponding to the base.

A third exemplary aspect of the invention provides a method of manufacturing an active matrix liquid crystal display device having a first substrate, a second substrate opposed to the first substrate and a liquid crystal layer sandwiched between the first substrate and the second substrate. The method includes: forming a scan signal line on the first substrate, a common signal line parallel to the scan signal line, a image signal line intersecting with the scan signal line and the common signal line, a thin film transistor formed at an intersection point of the scan signal line and the image signal line, a pixel electrode connected to one of electrodes of the thin film transistor, a common electrode connected to the common signal line, an insulating film between at least one of the scan signal line, the common signal line and the image signal line, and at least one of the pixel electrode and the common electrode, and a first concave portion on a surface of the first substrate on a side where the thin film transistor is formed; and forming a first column-shaped spacer on the second substrate at a position corresponding to the first concave portion, and a second column-shaped spacer on the second substrate at a different position from the position corresponding to the first concave portion. The first column-shaped spacer projects to the first substrate. A gap is formed between the first substrate and a tip of the first column-shaped spacer. The second column-shaped spacer projects to the first substrate and reaches the first substrate. A height of the second column-shaped spacer is equal to a height of the first column-shaped spacer.

A fourth exemplary aspect of the invention provides a method of manufacturing an active matrix liquid crystal display device having a first substrate, a second substrate opposed to the first substrate and a liquid crystal layer sandwiched between the first substrate and the second substrate. The method includes: forming a scan signal line on the first substrate, a common signal line parallel to the scan signal line, a image signal line intersecting with the scan signal line and the common signal line, a thin film transistor formed at an intersection point of the scan signal line and the image signal line, a pixel electrode connected to one of electrodes of the thin film transistor, a common electrode connected to the common signal line, an insulating film between at least one of the scan signal line, the common signal line and the image signal line, and at least one of the pixel electrode and the common electrode, and a base on a surface of the first substrate on a side where the thin field transistor is formed, by leaving the insulating film; and forming a first column-shaped spacer on the second substrate at a position corresponding to the base, and a second column-shaped spacer on the second substrate at a different position from the position corresponding to the base. The first column-shaped spacer projects to the first substrate and reaches the first substrate. The second column-shaped spacer projects to the first substrate. A gap is formed between the first substrate and a tip of the second column-shaped spacer. A height of the second column-shaped spacer is equal to a height of the first column-shaped spacer.

Thus, because the present application can form a step without forming the metal base pattern, the present application has an advantage based on structure of the auxiliary column. Furthermore, the present application can provide a high-quality liquid crystal display device without adverse effect on the signal transfer, due to no capacitive coupling and no short circuit of the column-shaped spacers with other electrode.

Other exemplary features and advantages of the present application will be apparent from the following description taken in conjunction with the accompanying drawings, in which like reference characters designate the same or similar parts throughout the figures thereof.

### BRIEF DESCRIPTION OF THE DRAWINGS

Exemplary features and advantages of the present application will become apparent from the following detailed description when taken with the accompanying drawings in which:

FIG. 1 is a plan view showing structure of a pixel of a liquid crystal display device according first to third embodiments of the present application;

FIG. 2 is a cross sectional view showing structure of the pixel of the liquid crystal display device according to the first embodiment of the present application;

FIG. 3A is a cross section showing structure of the pixel of the liquid crystal display device according to the second embodiment of the present application;

FIG. 3B shows steps of a procedure for forming a concave portion for an auxiliary column of the liquid crystal display device according to the second embodiment of the present application;

FIG. 4A is a cross sectional view showing structure of the pixel of the liquid crystal display device according to the third embodiment of the present application;

FIG. 4B shows steps of a procedure for forming a base for a main column in the liquid crystal display device according to the third embodiment of the present application;

FIG. 5 is a plan view showing structure of the pixel of the liquid crystal display device according to fourth to sixth embodiments of the present application;

FIG. 6 is a cross sectional view showing structure of the pixel of the liquid crystal display device according to the fourth embodiment of the present application;

FIG. 7 is a cross sectional view showing structure of the pixel of the liquid crystal display device according to the fifth embodiment of the present application;

FIG. 8A is a cross sectional view showing structure of the pixel of the liquid crystal display device according to the sixth embodiment of the present application;

FIG. 8B shows steps of a procedure for forming the base for the main column in the liquid crystal display device according to the sixth embodiment of the present;

FIG. 9 is a plan view showing structure of the pixel of the liquid crystal display device according to a seventh to a ninth embodiments;

FIG. 10 is a cross sectional view showing structure of the pixel of the liquid crystal display device according to the seventh embodiment of the present application;

FIG. 11 is a cross sectional view showing structure of the pixel of the liquid crystal display device according to the eighth embodiment of the present application;

FIG. 12 is a cross sectional view showing structure of the pixel of the liquid crystal display device according to the ninth embodiment of the present application;

FIG. 13 is a plan view showing structure of the pixel of the liquid crystal display device according to tenth and eleventh embodiments;

FIG. 14 is a cross sectional view showing structure of the pixel of the liquid crystal display device according to the tenth embodiment of the present application;

FIG. 15 is a cross sectional view showing structure of the pixel of the liquid crystal display device according to the eleventh embodiment of the present application;

FIGS. 16A and 16B are schematic diagrams illustrating the effect of the auxiliary column structure of the conventional liquid crystal display device;

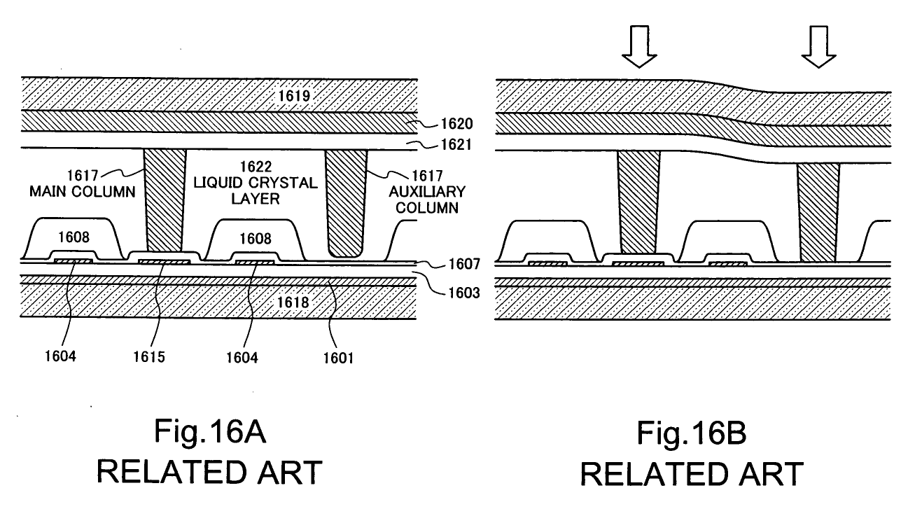

FIG. 17 is an example of plan view showing structure of the pixel of the conventional liquid crystal display device; and

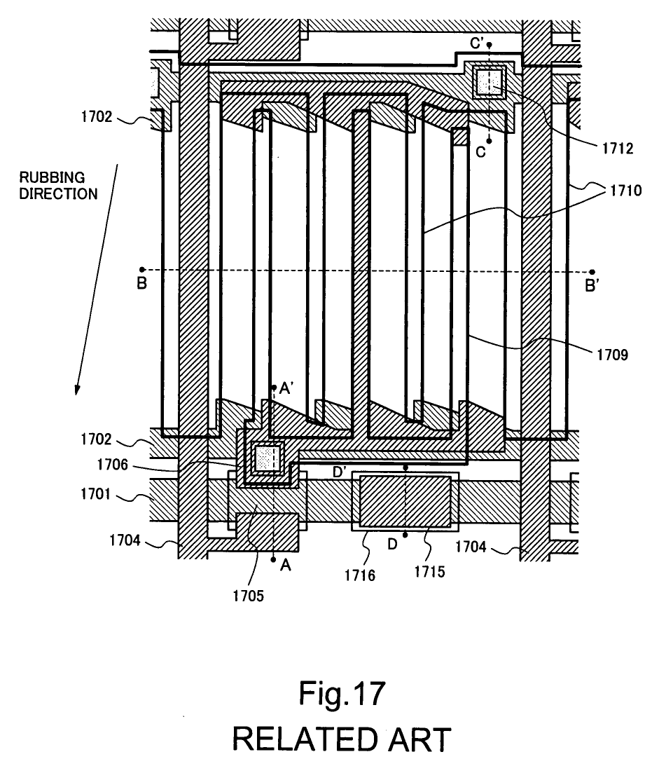

FIG. 18 is an example of cross sectional view of the pixel of the conventional liquid crystal display device.

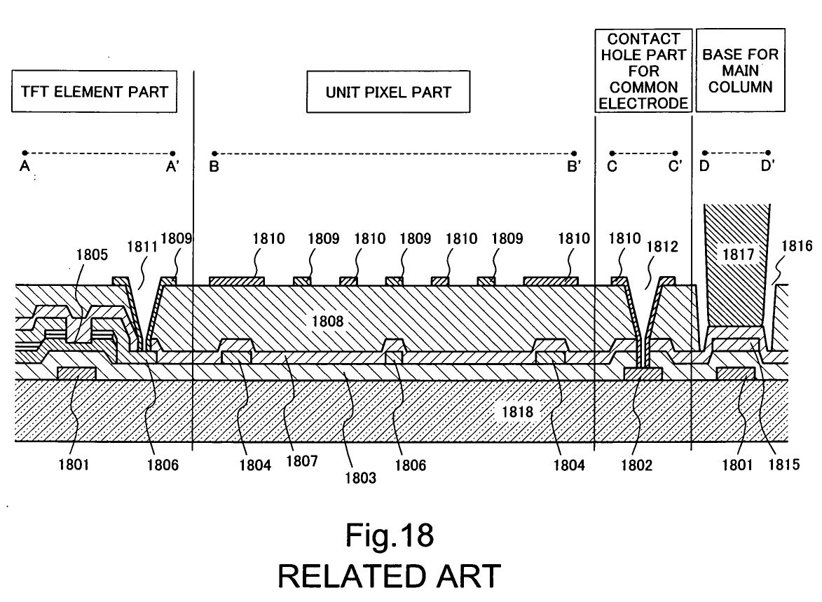

### DETAILED DESCRIPTION OF THE EXEMPLARY EMBODIMENTS

Exemplary embodiments of the present application will now be described in detail in accordance with the accompanying drawings.

An active matrix liquid crystal display device of the present application includes a substrate (hereinafter, to be referred to as a TFT substrate) in which switching elements such as TFT are formed, another substrate (hereinafter, to be referred to as an opposite substrate) and a liquid crystal interposed therebetween.

The opposite substrate of the active matrix liquid crystal display device according to the color display method is a transparent insulating substrate made of glass or the like on which color layers in RedGreenBlue (RGB) colors, a black matrix for blocking unnecessary light off and the like are formed. In order to hold a gap between the TFT substrate and the opposite substrate, a plurality of column-shaped spacers with almost the same height are formed at predetermined positions on the black matrix, and the spacers project to the TFT substrate. On the other hand, on an opposite substrate of the active matrix liquid crystal display device according to the monochrome method, the black matrix and the column-shaped spacers can be formed without forming the color layers in RGB colors. These column-shaped spacers are formed by partially exposing the photosensitive resin material. The column-shaped spacers include the main column which has contact with the TFT substrate in case of no external force being applied and the auxiliary column which has contact with the TFT substrate in case of the external force being applied. Further, the column-shaped spacers may be formed in various methods. The TFT substrate includes a transparent insulating substrate made of glass or the like, on which a scan signal line and an image signal line are arranged so as to intersect with each other at a predetermined angle, and a common signal line is arranged substantially parallel to the scan signal line. TFT is arranged in each pixel surrounded by the scan signal line and the image signal line. A source electrode is connected to the image signal line, and a drain electrode is connected to a pixel electrode which extends along the image signal line in the pixel. Alternatively, the drain electrode may be connected to the image signal line and the source electrode may be connected to the pixel electrode. A common electrode which extends along the image signal line in the pixel is connected to the common signal line. The pixel electrode and the common electrode are arranged alternately to form a comb-like electrode. Then, the liquid crystal is driven in each pixel, through horizontal electric field generated between the pixel electrode with a pixel potential supplied from the image signal line via TFT, and the common electrode with a common potential.

A concave portion is formed in the TFT substrate through etching a part of the TFT substrate corresponding to the auxiliary column position so that a part corresponding to the main column of the column-shaped spacer and the part corresponding to the auxiliary column of the column-shaped spacer be different each other in height. Alternatively, a concave portion may be formed in the TFT substrate through etching a part of a passivation film corresponding to the auxiliary column position. Further, alternatively, a base may be formed in the TFT substrate through etching the overcoat film leaving a part corresponding to the main column position, to leave the film with a predetermined thickness.

Since a height difference can be acquired without forming a metal base pattern, advantage due to structure of the auxiliary column is obtained. In case that a vertical external force is applied to the substrate, the substrate receives the external force in a dispersive manner. In case that an external force is applied parallel to the substrate surface and then is released, the substrates return to an initial position. Such structure of the auxiliary column advantageously prevents adverse effect on the signal transfer due to capacitive coupling and prevents short circuit of the column-shaped spacers with other electrode.

Consequently, a liquid crystal display device with high-quality can be provided.

Further, according to the present application, the column-shaped spacers are formed on the opposite substrate and the steps are formed in the TFT substrate. Alternatively, the column-shaped spacers may be formed on the TFT substrate and the steps may be formed in the opposite substrate. In the following, it will be described that the liquid crystal display device adopts the horizontal electric field application method. Alternatively, the liquid crystal display device may adopt other liquid crystal display method such as a vertical electric field application method. In the following, it will be described that structure of the TFT is an inverted-stagger type having a semiconductor layer on an upper layer of a gate electrode. Alternatively, a normal-stagger type having the gate electrode on the upper layer of the semiconductor layer is also applicable. Moreover, in the following, it will be described that the column-shaped spacer is formed at the position of the scan signal line on the TFT substrate. Alternatively, the column-shaped spacer may be formed at the position of the common signal line or of the image signal line instead of the scan signal line. Further, the column-shaped spacer may be formed also at the position of the common signal line or of the image signal line in addition to the scan signal line.

Hereinafter, as an exemplary embodiment of the present application, the IPS liquid crystal display device will be described with reference to drawings. Specifically, structure of the concave portion and the base and manufacturing method thereof will be described.

### First Exemplary Embodiment

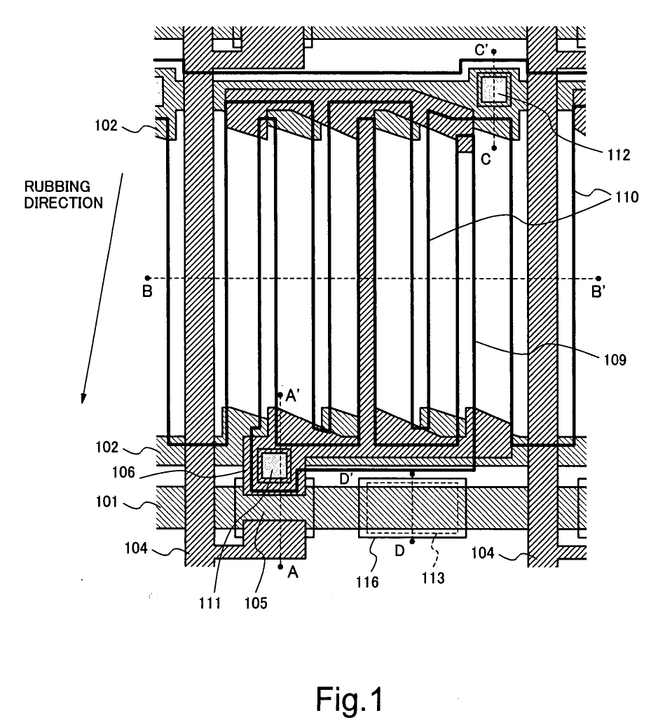

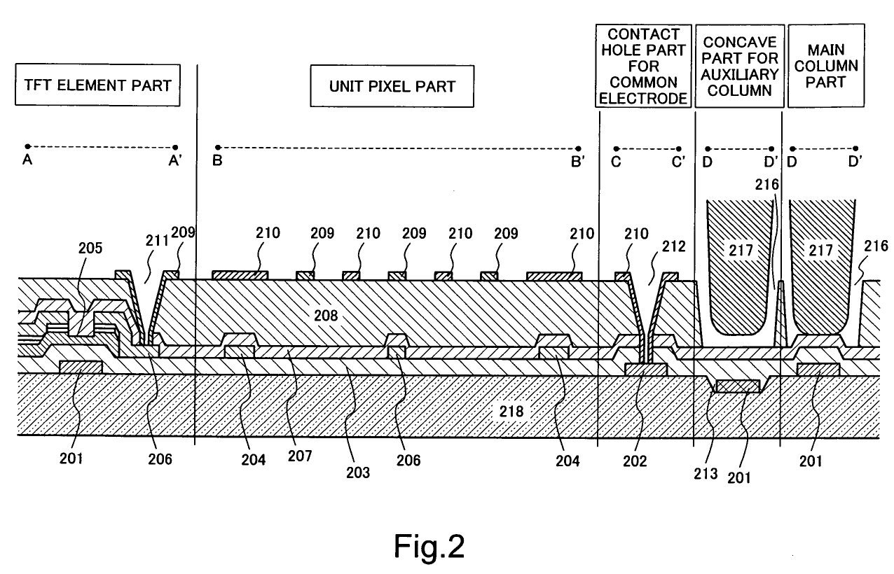

FIG. 1 is a plan view showing a structure of a pixel of the TFT substrate included in the liquid crystal display device according to the first exemplary embodiment is composed. FIG. 2 is a cross sectional view taking along the dashed lines in FIG. 1, showing a structure of the pixel indicated by dashed lines. Further, a cross sectional view noted by DD′, in case of having no concave portion 113, is added.

By etching in advance, a concave portion 213 is formed in a TFT substrate 218 at a position opposed to an auxiliary column of a columnar spacer 217 which is formed on an opposite substrate to the TFT substrate. The concave portion 213 can be formed easily through performing the wet etching after the usual exposure process using a photomask. In case that a step formed by the concave portion 213 is too large, the auxiliary column does not have contact with the TFT substrate, even though an external force vertical to the substrate is applied. Consequently, the step formed by the concave portion 213 does not operate as a desired auxiliary column. On the other hand, in case that the step formed by the concave portion 213 is too small, the auxiliary column may have contact with the TFT substrate when the external force is not applied. It is preferable that the step formed by the concave portion 213 is from 200 nm to 300 nm in thickness. Further, according to the first exemplary embodiment, the concave portion 213 is not formed at the position corresponding to a main column of the column-shaped spacer 217.

A scan signal line 201 and the common signal line 202 parallel to the scan signal line 201, which are made of the first metal layer of Cr (Chromium) or the like, are formed on the etched TFT substrate 218. Thicknesses of the scan signal line 201 and the common signal line 202 are not limited. In case that the thicknesses of these signal lines are the same as the depth of the concave portion 213 of the TFT substrate 218, the surface with which the auxiliary column has contact becomes substantially flat.

A gate insulation film 203 made of insulating material such as SiOx or SiNx is formed on the scan signal line 201 and the common signal line 202. An island-shaped semiconductor layer made of amorphous silicon, polysilicon or the like is formed on the gate insulation film 203. Further, an image signal line 204 which is made of a second metal layer of Cr or the like is formed on the gate insulation film 203. A source electrode 206 is formed and then a thin film transistor 205 is formed on the gate insulation film 203. A passivation film 207 made of insulating material of SiNx or the like is formed on the image signal line 204, the thin film transistor 205 and the source electrode 206. An overcoat film 208 having photosensitivity is applied on the passivation film 207.

The overcoat film 208 is a transparent film made of acrylic resin, for example. Parts of the overcoat film 208 which correspond to positions of a contact hole 211 between the pixel electrode and the source electrode, a contact hole 212 between the common electrode and the common signal line and a hole 216 in which the auxiliary column is fitted are removed by exposure. A part of the passivation film 207, which corresponds to the position of the removed overcoat film 208, is removed by etching, and then, the contact hole 211 between the pixel electrode and the source electrode is formed. The gate insulation film 203 and the passivation film 207 are removed, and then, the contact hole 212 between the common electrode and the common signal line is formed. After this, a pixel electrode 209 and a common electrode 210, which include transparent electrodes made of ITO (Indium Thin Oxide) or the like, are formed. The common electrode 210 is formed also on the image signal line 204 in order to shield electric field. The pixel electrode 209 is electrically connected with the source electrode 206 via the contact hole 211. The common electrode 210 is electrically connected with the common signal line 202 via the contact hole 212.

According to the structure, in case that an external force is not applied, the column-shaped spacer 217 as the main column has contact with the TFT substrate 218 at the position 214 where is not etched. The column-shaped spacer 217 as the auxiliary column does not have contact with the TFT substrate 218 due to the concave portion 213. Accordingly, the step is formed without arranging the metal base pattern, and consequently, the structure of the auxiliary column is advantageous. Moreover, adverse effect on the signal transfer due to capacitive coupling, and short circuit of the column-shaped spacer with other electrodes are prevented. With regard to the manufacturing method according to the first exemplary embodiment, the number of exposure increases by one comparing to the conventional art, because the TFT substrate 218 is etched in advance. The subsequent processes are the same as those of the conventional art.

### Second Exemplary Embodiment

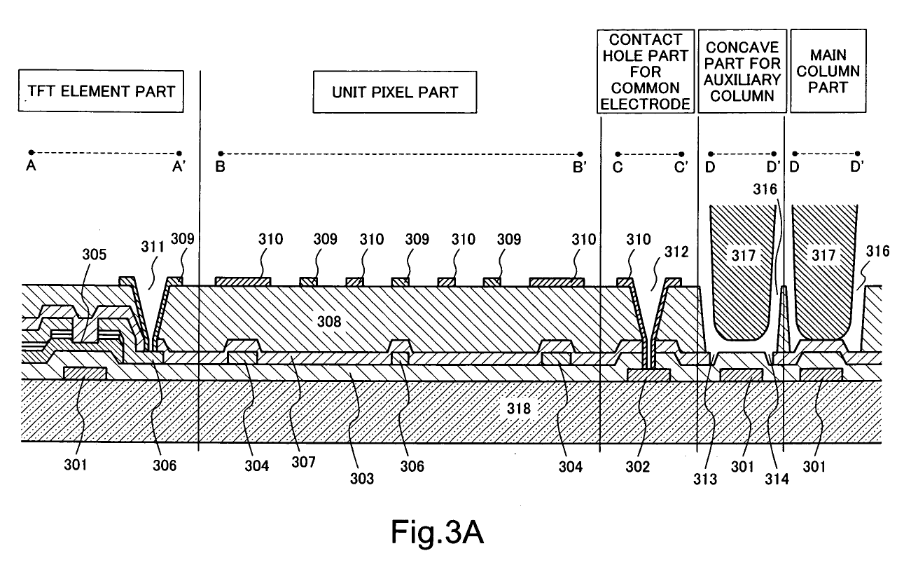

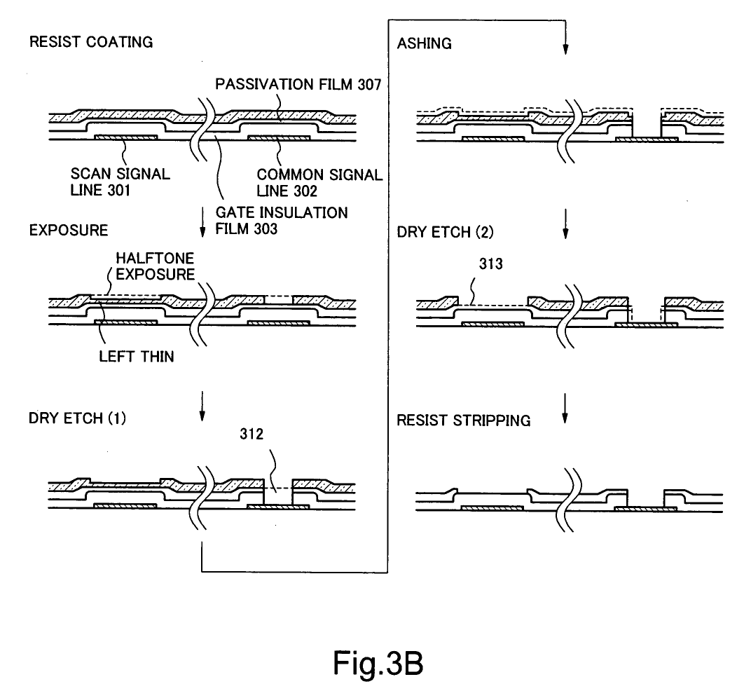

Next, a liquid crystal display device and its manufacturing method according to a second exemplary embodiment of the present application will be described with reference to FIGS. 3A and 3B. FIG. 3A is a cross sectional view showing structure of the liquid crystal display device according to the second exemplary embodiment. FIG. 3B schematically shows a cross section of each sequential process in which the concave portion for the auxiliary column is formed. Further, a plan view is the same as FIG. 1. Further, a cross section indicated by DD′ is added in case of having no concave portion 113. The difference from the first exemplary embodiment is in the method of manufacturing a concave portion 313 which is formed at a position opposed to the auxiliary column of a column-shaped spacer 317. The concave portion 313 is formed through etching not a TFT substrate 318 but a passivation film 307. Other steps are the same as those of the first exemplary embodiment.

The forming method of the concave portion 313 is shown in FIG. 3B. In the exposure process for forming a contact hole 312, a part of a resist film at a position to form the contact hole 312 (right side of the swung dash line in the figure) is removed completely by an usual exposure process. On the other hand, a part of the resist film at a position to form the concave portion 313 (left side of the swung dash line in the figure) is left thin by the halftone exposure process (refer to exposure in the figure). After the first etching, a passivation film 307 and a gate insulation film 303 are removed completely, and then, the contact hole 312 is formed (refer to dry etch 1 in the figure). Next, the resist film which is left thin at the position to form the concave portion 313 is removed by ashing (refer to ashing in the figure). After the second etching, the passivation film 307 and the gate insulation film 303 are removed (refer to dry etch 2 in the figure) and the rest of the resist film of other portion are removed and the concave portion 313 is formed consequently (refer to resist stripping in the figure). It is preferable that the height difference of the concave portion 313 formed by the passivation film 307 and the gate insulation film 303 is from 200 nm to 300 nm in depth as in the first embodiment.

Thus, in case that the external force is not applied, the column-shaped spacer 317 as the main column has contact with the TFT substrate 318 at an unetched position 314. The column-shaped spacer 317 as the auxiliary column does not have contact with the TFT substrate 318 due to the concave portion 313. As the above mentioned, the second exemplary embodiment obtains the same advantage as in the first exemplary embodiment. Further, according to the manufacturing method of the second exemplary embodiment, the number of etching process increases by one than that of the conventional art, but the number of exposure processes does not increase.

### Third Exemplary Embodiment

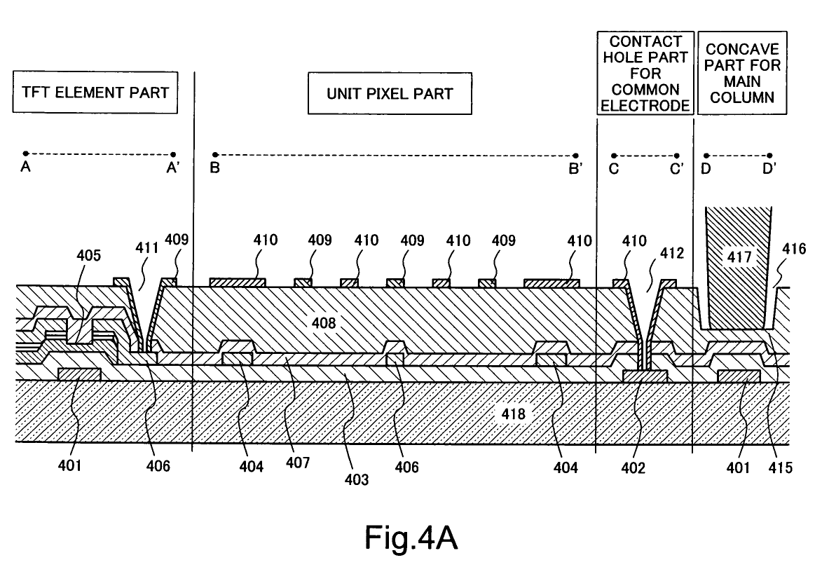

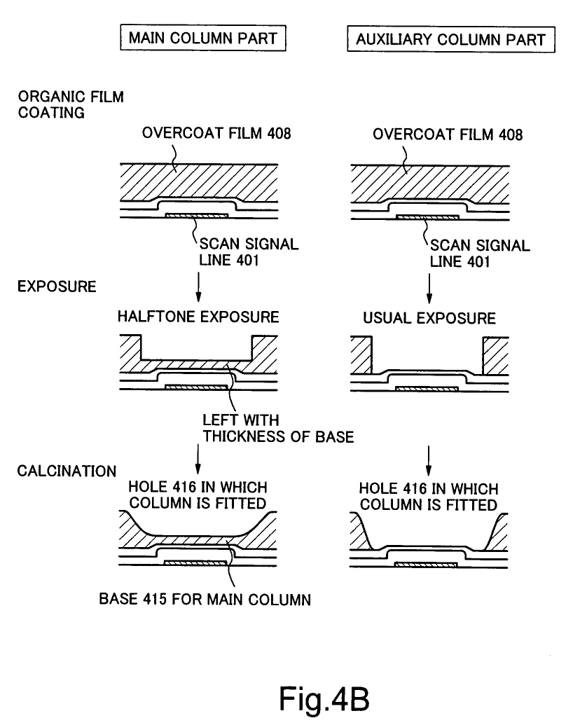

A liquid crystal display device and its manufacturing method according to a third exemplary embodiment of the present application will be described with reference to FIGS. 4A and 4B. FIG. 4A is a cross sectional view showing a structure of the liquid crystal display device according to the third exemplary embodiment. FIG. 4B schematically shows a cross sectional view of each sequential process for manufacturing the base for the main column. Further, a plan view of this embodiment is the same as FIG. 1. The main column is fitted to a hole 416 in a overcoat film which receives the column of FIG. 1.

The difference from the first and second exemplary embodiments is in a shape of the base arranged at a position opposed to a column-shaped spacer 417. According to the third exemplary embodiment, the base is not the concave portion which is formed at a position opposed to the auxiliary column of the column-shaped spacer 417, but a convex portion at a position opposed to the main column of the column-shaped spacer 417. This convex portion is formed through leaving the photosensitive organic film (i.e. overcoat film 408) with the predetermined thickness in a halftone exposure process. Other structure is the same as the first and second exemplary embodiment.

As shown in FIG. 4B, a part of an overcoat film 408 which corresponds to a position of the auxiliary column (right side of the figure) is removed by a usual exposure process, and then, the hole 416 is formed. A part of the overcoat film 408 which corresponds to the position of the main column position (left side of the figure) is left with the predetermined thickness by a halftone exposure process (refer to exposure in the figure), and consequently, the part left with the predetermined thickness forms a base 415 (refer to calcination in the figure). It is preferable that thickness of the base 415 ranges from 200 nm to 300 nm.

In case that the external force is not applied, the column-shaped spacer 417 as the main column has contact with a TFT substrate 418 due to the base 415. The column-shaped spacer 417 as the auxiliary column does not have contact with the TFT substrate 418 where the base 415 is not formed. Accordingly, the same advantage as the above mentioned is obtained. Further, according to the manufacturing method of the third exemplary embodiment, the number of processes does not increase in comparison with the conventional art.

### Fourth Exemplary Embodiment

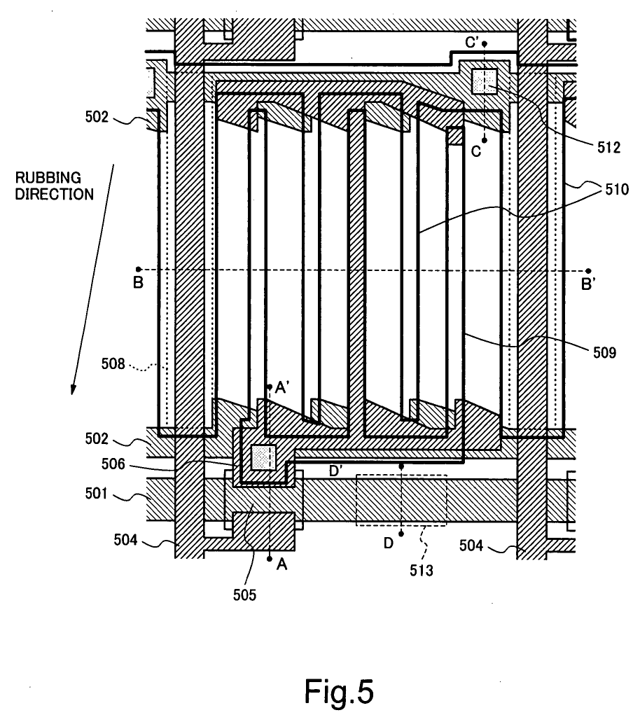

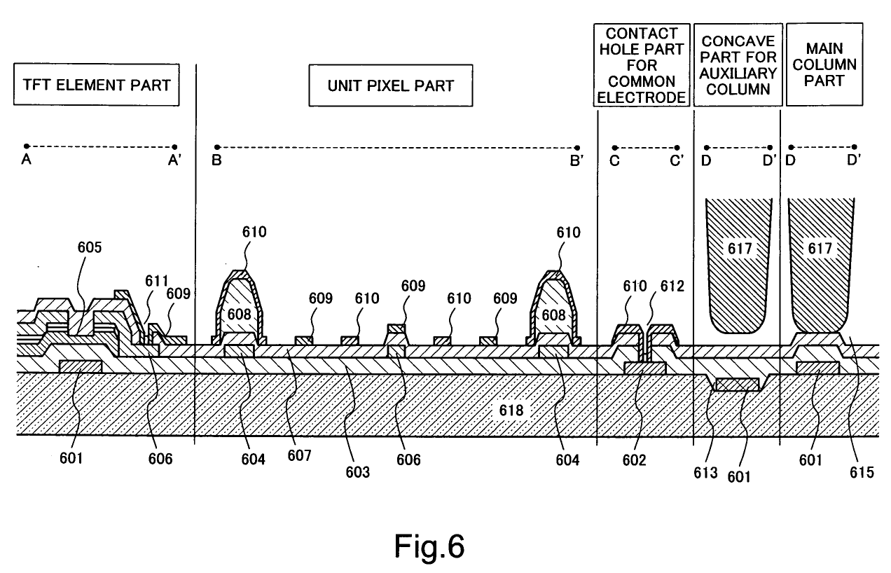

Next, a liquid crystal display device and manufacturing method thereof according to a fourth exemplary embodiment of the present application will be described with reference to FIGS. 5 and 6. FIG. 5 is a plan view showing a structure of a pixel on the TFT substrate included in the liquid crystal display device according to the fourth exemplary embodiment. FIG. 6 is a cross sectional view taking along the dashed lines in FIG. 5 showing a structure of the pixel indicated by the dashed lines. Further, a cross section indicated by DD′ is added, in case of having no concave portions 513.

It is different from the first exemplary embodiment that an overcoat film 608 with photosensitivity is removed except for a region above an image signal line. Other steps are the same as the first exemplary embodiment.

As shown in FIG. 6, a concave portion 613 is formed in a TFT substrate 618 at a position opposed to the auxiliary column by etching in advance. A scan signal line 601 and a common signal line 602 parallel to the scan signal line 601 are formed on a TFT substrate 618. A gate insulation film 603 is formed over those lines. An island-shaped semiconductor layer and an image signal line 604 are formed on the gate insulation film 603. A source electrode 606 is formed on the gate insulation film 603, and then, a thin film transistor 605 is formed. A passivation film 607 is formed over those lines and the TFT.

An overcoat film 608 having photosensitivity is applied over the passivation film 607. By exposure, the overcoat film 608 is removed except for a region on the image signal line 604. Since the overcoat film 608 within a display area is removed, the overcoat film is not limited to a transparent film and for example, a colored film such as novolac resin is also applicable to the overcoat film.

Then, the gate insulation film 603 and the passivation film 607 are removed by etching, and then, a contact hole 611 between the pixel electrode and the source electrode and a contact hole 612 between the common electrode and the common signal line are formed. Afterward, a pixel electrode 609 and a common electrode 610 which include transparent electrodes are formed.

Thus, in case that an external force is not applied, a column-shaped spacer 617 as the main column has contact with the TFT substrate 618 at an unetched position 614. The column-shaped spacer 617 as the auxiliary column does not have contact with the TFT substrate 618 due to a concave portion 613. Therefore, the same advantage as in the first to third exemplary embodiments is obtained. According to the manufacturing method of the fourth exemplary embodiment, the number of an exposure process increases by one than that of the conventional art since etching the substrate in advance is required as in the first exemplary embodiment. The subsequent processes for manufacturing are the same as those of the conventional art.

### Fifth Exemplary Embodiment

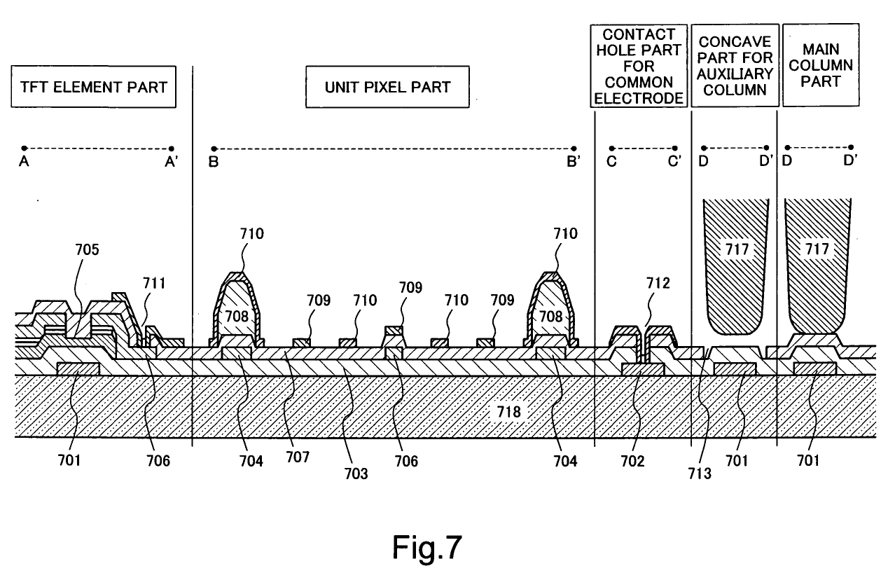

Next, a liquid crystal display device and manufacturing method thereof according to a fifth exemplary embodiment of the present application will be described with reference to FIG. 7. FIG. 7 is a cross sectional view showing a structure of the liquid crystal display device according to the fifth exemplary embodiment. A plan view is the same as FIG. 5. Further, a cross sectional view indicated by DD′ is added in case of having no concave portion 513.

It is different from the fourth exemplary embodiment that a concave portion 713 is formed through etching not the substrate, but a passivation film 707. The other structure is the same as in the fourth exemplary embodiment. The method of forming the concave portion 713 is the same as the method shown in FIG. 3B.

Thus, in case that an external force is not applied, a column-shaped spacer 717 as the main column has contact with a TFT substrate 718 at an unetched position 714. The column-shaped spacer 717 as the auxiliary column does not have contact with the TFT substrate 718 due to a concave portion 713. For this reason, the same advantage as in the fourth exemplary embodiment is obtained. Further, according to the manufacturing method of the fifth exemplary embodiment, the number of etching process increases by one than that of the conventional art. The number of exposure does not increase in comparison with the conventional art.

### Sixth Exemplary Embodiment

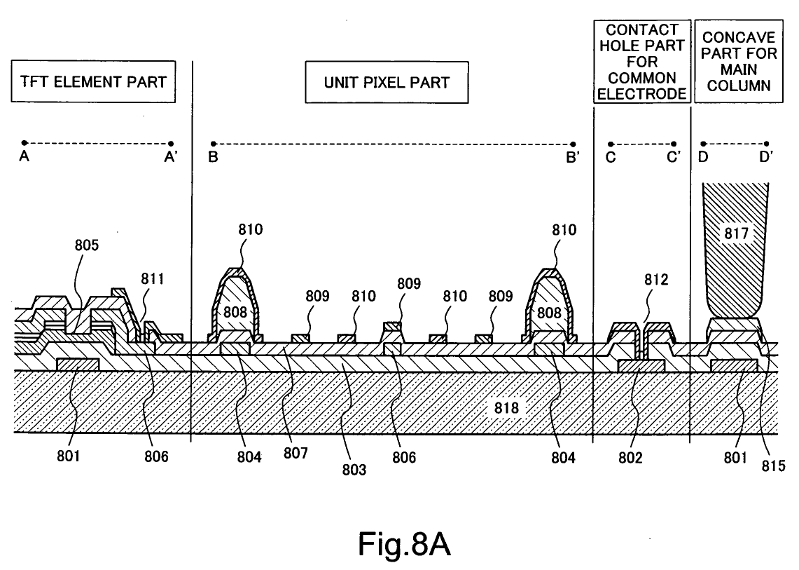

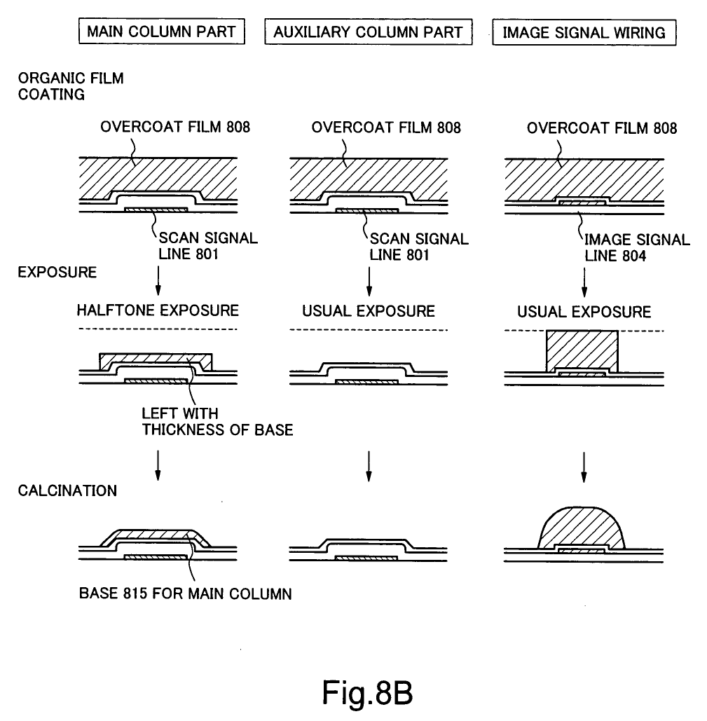

Next, a liquid crystal display device and manufacturing method thereof according to a sixth exemplary embodiment of the present application will be described with reference to FIGS. 8A and 8B. FIG. 8A is a cross sectional view showing a structure of the liquid crystal display device according to the sixth exemplary embodiment. FIG. 8B schematically shows a cross sectional view of each sequential process in which a base for the main column is formed. Further, a plan view is the same as FIG. 5. The difference from the fourth and fifth exemplary embodiments is in a shape of the base at the position opposed to a column-shaped spacer 817. According to the sixth exemplary embodiment, the base is not a concave portion formed in a TFT substrate 818 but a convex portion formed by leaving a photosensitive overcoat film 808 with predetermined thickness in a halftone exposure process. The other structure is the same as in the fourth and fifth embodiments.

As shown in FIG. 8B, a part of the overcoat film 808 which corresponds to a position of the auxiliary column (central portion of the figure) and most of the overcoat film 808 except for a region above an image signal line (right portion of the figure) are removed by an usual exposure process. On the other hand, a part of the overcoat film which corresponds to a position of the main column (left portion of the figure) is left with predetermined thickness in the halftone exposure process (refer to exposure in the figure), and consequently, the part left with the predetermined thickness is made to be a base 815 (refer to calcination in the figure). It is preferable that thickness of the base 815 ranges from 200 nm to 300 nm.

Thus, in case that an external force is not applied, through providing a height difference in the TFT substrate 818, the column-shaped spacer 817 as the main column has contact with the TFT substrate 818 due to the base 815. In contrast, the column-shaped spacer 817 as the auxiliary column does not have contact with the TFT substrate 818 where the base 815 is not formed. Therefore, the same advantage as in the fourth and the fifth exemplary embodiments is obtained. Further, with regard to the manufacturing method according to the sixth exemplary embodiment, the number of process does not increase in comparison with the conventional art.

### Seventh Exemplary Embodiment

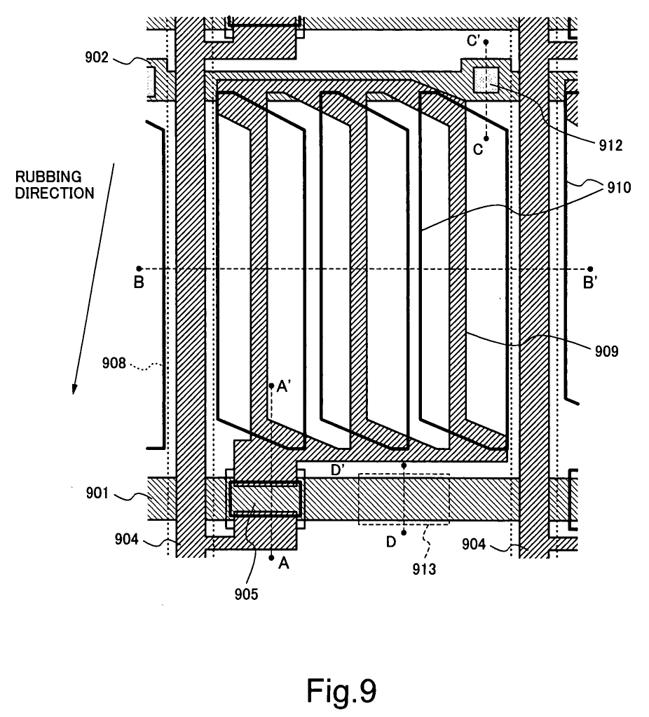

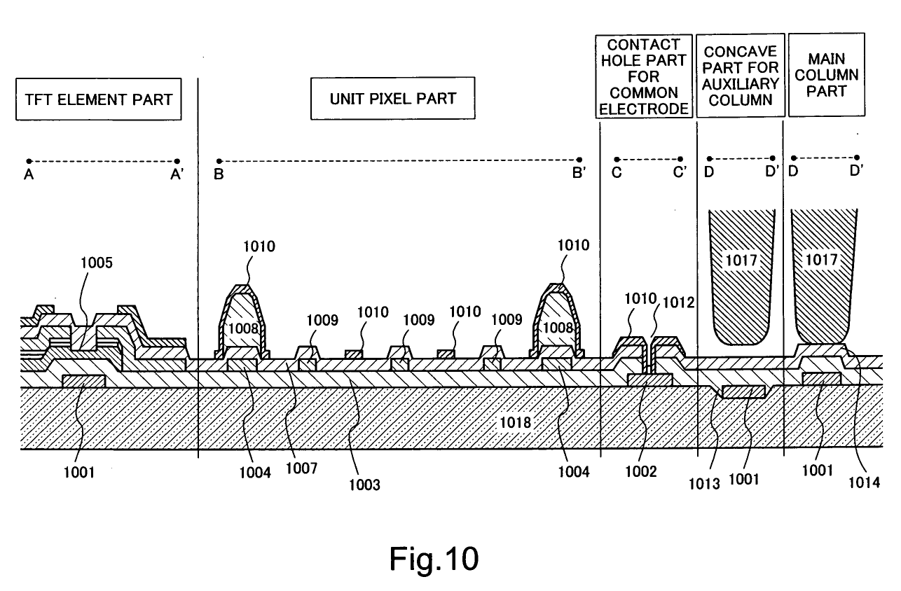

A liquid crystal display device and manufacturing method thereof according to a seventh exemplary embodiment of the present application will be described with reference to FIGS. 9 and 10. FIG. 9 is a plan view showing a structure of a pixel on the TFT substrate included in the liquid crystal display device according to the seventh exemplary embodiment. FIG. 10 is a cross sectional view of a structure of a part taking along the dashed lines in FIG. 9. Further, a cross section noted by DD′ is added, in case of having no concave portions 913.

It is different from the fourth exemplary embodiment that a pixel electrode 1009 is formed simultaneously on the same layer as an image signal line 1004. The other processes are the same as in the fourth exemplary embodiment.

As shown in FIG. 10, in a TFT substrate 1018, a concave portion 1013 is formed at a position opposed to the auxiliary column through etching the TFT substrate in advance. A scan signal line 1001 and a common signal line 1002 parallel to the scan signal line 1001, which are made of the first metal layer of Cr or the like, are formed on the TFT substrate 1018. A gate insulation film 1003 is formed over the scan signal line 1001 and the common signal line 1002, and then, an island-shaped semiconductor layer is formed on the gate insulation film 1003. Moreover, an image signal line 1004 which is made of the second metal layer is formed on the gate insulation film 1003. A pixel electrode 1009 is formed on the gate insulation film 1003, and then, a thin film transistor 1005 is formed. A passivation film 1007 is formed over the image signal line 1004, the thin film transistor 1005 and the pixel electrode 1009.

An overcoat film 1008 with photosensitivity is applied over the passivation film 1007. The overcoat film 1008 is removed except for a region above the image signal line. Since the overcoat film 1008 within the display area is removed, the overcoat film is not limited to a transparent film. For example, a colored film such as novolac resin is also applicable. The gate insulation film 1003 and the passivation film 1007 are removed by etching, and then, a contact hole 1012 between the common electrode and the common signal line is formed.

After this, a common electrode 1010 including a transparent electrode is formed. The common electrode 1010 is formed also on the image signal line 1004, and then, an electric field is shielded. The common electrode 1010 is electrically connected with the common signal line 1002 via a contact hole 1012.

Thus, in case that an external force is not applied, by forming a height difference in the TFT substrate 1018, the column-shaped spacer 1017 as the main column has contact with the TFT substrate 1018 at an unetched position 1014. In contrast, the column-shaped spacer 1017 as the auxiliary column does not have contact with the TFT substrate 1018 due to the concave portion 1013. For this reason, the same advantage as in the fourth exemplary embodiment is obtained. Further, with regard to the manufacturing method according to the seventh exemplary embodiment, the number of exposure process increases by one than that of the conventional art, since etching the substrate in advance is required. But the subsequent manufacturing processes are the same as in the conventional art.

### Eighth Exemplary Embodiment

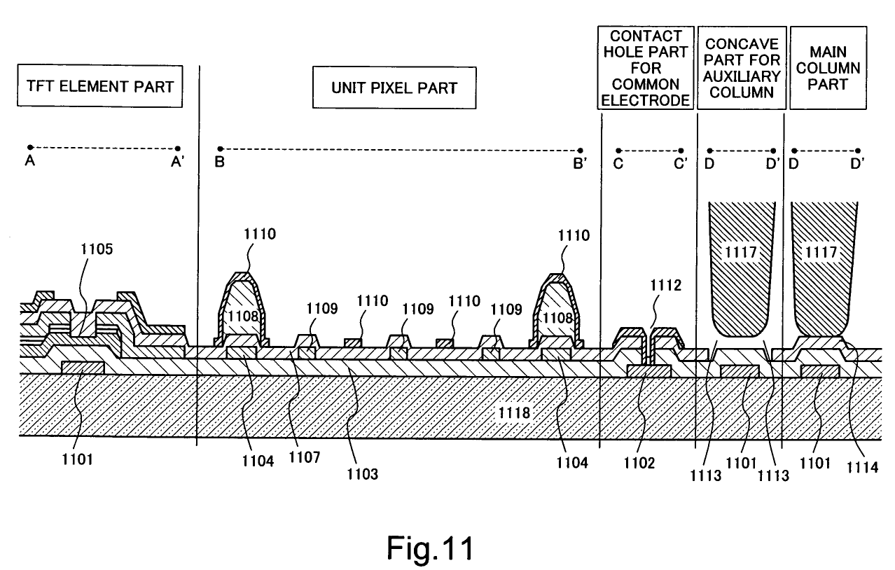

A liquid crystal display device and its manufacturing method according to an eighth embodiment of the present application will be described with reference to FIG. 11. FIG. 11 is a cross sectional view showing a structure of the liquid crystal display device according to the eighth exemplary embodiment. A plan view is the same as FIG. 9. Further, a cross sectional view indicated by DD′ is added, in case of having no concave portions 1113.

It is different from the seventh exemplary embodiment that a concave portion 1113 is formed through etching not the substrate but etching a passivation film 1107. The other structure is the same as in the seventh exemplary embodiment. The method of forming the concave portion 1113 is the same as the method shown in FIG. 3B. Thus, in case that an external force is not applied, through forming a step in a TFT substrate 1118, a column-shaped spacer 1117 as the main column has contact with the TFT substrate 1118 at an unetched position 1114. In contrast, the column-shaped spacer 1117 as the auxiliary column does not have contact with the TFT substrate 1118 due to the concave portion 1113. For this reason, the same advantage as in the seventh exemplary embodiment is obtained. According to the manufacturing method of the eighth exemplary embodiment, the number of etching processes increases by one compared with the conventional art. But the number of exposures does not increase in comparison with the conventional art.

### Ninth Exemplary Embodiment

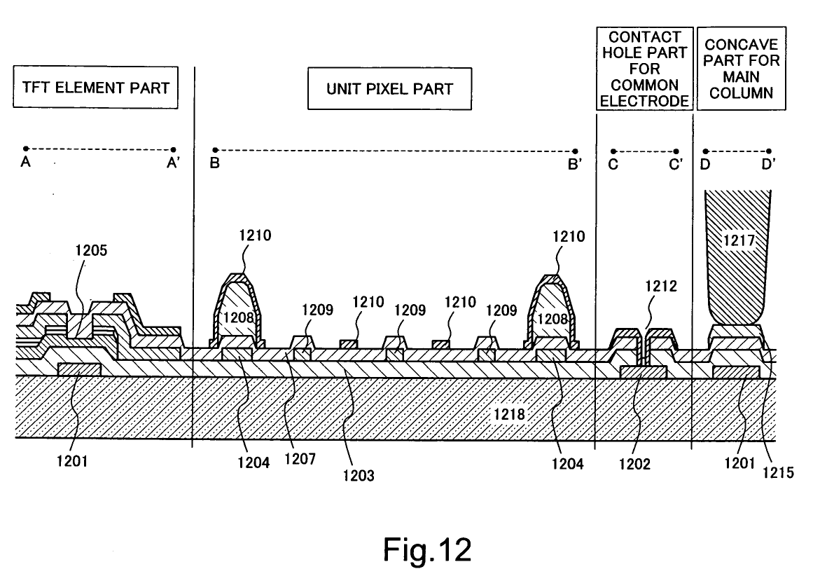

A liquid crystal display device and manufacturing method thereof according to a ninth exemplary embodiment of the present application will be described with reference to FIG. 12. FIG. 12 is a cross sectional view showing a structure of the liquid crystal display device according to the ninth exemplary embodiment. Further, a plan view is the same as FIG. 9.

The difference from the seventh and eighth embodiments is in the shape of the base opposed to a column-shaped spacer 1217. According to the ninth exemplary embodiment, a base is not a concave portion but a convex portion formed through leaving a photosensitive overcoat film 1208 with the predetermined thickness in a halftone exposure process. The other structure is the same as in the seventh and eighth embodiments.

As described in FIG. 8B, a part of the overcoat film 1208 which corresponds to a position of the auxiliary column and most of the overcoat film 1208 except for a region above an image signal line 1204 are removed in a usual exposure process. Apart of the overcoat film 1208 which corresponds to the position of the main column is left with the predetermined thickness in the halftone exposure process, and the part left with the predetermined thickness is made to be the base 1215. It is preferable that thickness of the base ranges from 200 nm to 300 nm.

Thus, in case that an external force is not applied, through forming a height difference in a TFT substrate 1218, the column-shaped spacer 1217 as the main column has contact with the TFT substrate 1218 due to the base 1215. In contrast, the column-shaped spacer 1217 as the auxiliary column does not have contact with the TFT substrate 1218 where the base 1215 is not formed. For this reason, the same advantage as in the seventh and eighth embodiments is obtained. With regard to the manufacturing method according to the ninth exemplary embodiment, the number of the processes does not increase in comparison with the conventional art.

### Tenth Exemplary Embodiment

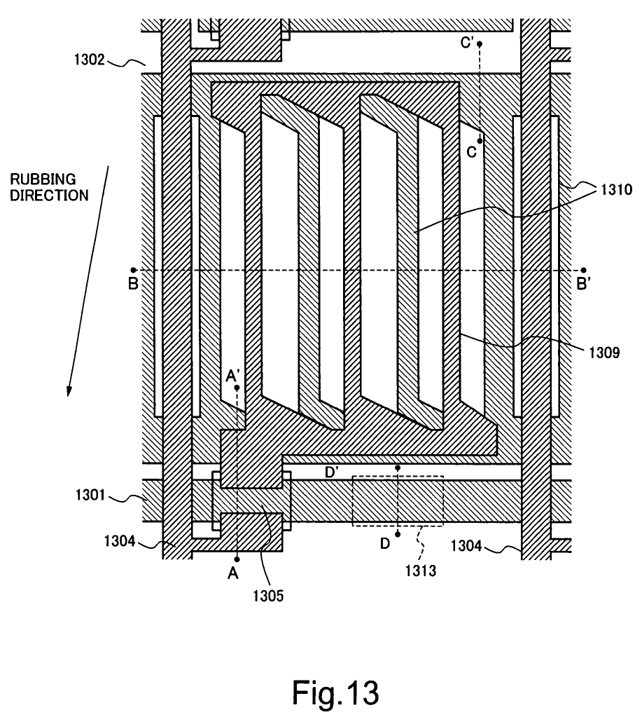

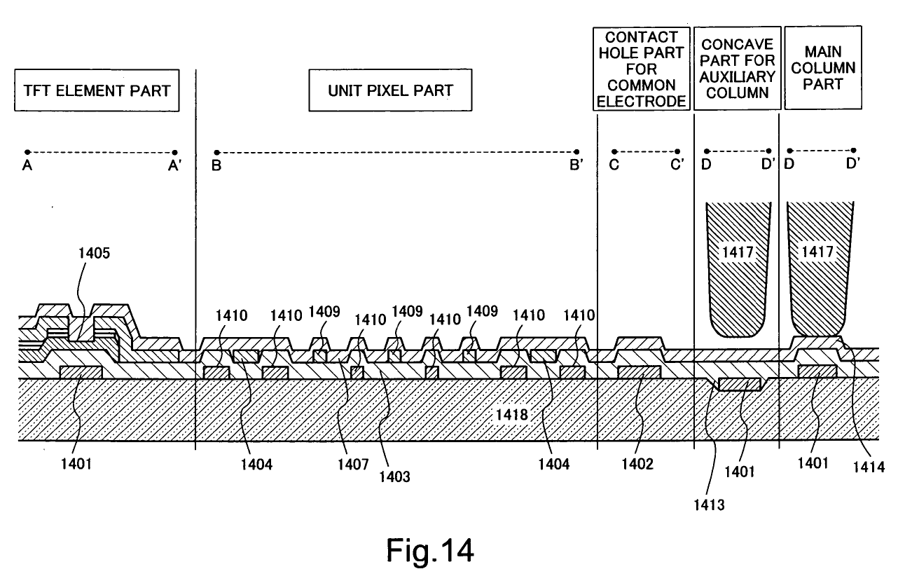

A liquid crystal display device and manufacturing method thereof according to a tenth embodiment of the present application will be described with reference to FIGS. 13 and 14. FIG. 13 is a plan view showing a structure of a pixel in a TFT substrate included in the liquid crystal display device according to the tenth exemplary embodiment. FIG. 14 is a cross sectional view of a structure of a part taking along the dashed lines in FIG. 13. Further, a cross sectional view noted by DD′ is added, in case of having no concave portions 1313. According to the tenth exemplary embodiment, a common electrode 1410 is formed simultaneously in the same layer as a scanning signal electrode 1401 and a common signal line 1402. A pixel electrode 1409 is formed simultaneously in the same layer as an image signal line 1404. On the other hand, an overcoat film is not formed. As shown in FIG. 14, a concave portion 1413 is formed at a position opposed to the auxiliary column through etching a TFT substrate 1418 in advance. The scan signal line 1401, the common signal line 1402 parallel to the scan signal line 1401 and a common electrode 1410, which are made of a first metal layer of Cr or the like are formed on the TFT substrate 1418. A gate insulation film 1403 is formed over the scan signal line 1401, the common signal line 1402 and the common electrode 1410. An island-shaped semiconductor layer is formed on the gate insulation film 1403. Moreover, the image signal line 1404 and the pixel electrode 1409, which are made of the second metal layer, are formed on the gate insulation film 1403, and then, a thin film transistor 1405 is formed. A passivation film 1407 is formed over the image signal line 1404, the thin film transistor 1405 and the pixel electrode 1409.

According to the structure, the pixel does not include a contact hole and, in contrast, a terminal includes a contact hole. The contact hole of the terminal is formed by etching.

Thus, in case that an external force is not applied, a column-shaped spacer 1417 as the main column has contact with the TFT substrate 1418 at an unetched position 1414, by forming a height difference in the TFT substrate. In contrast, the column-shaped spacer 1417 as the auxiliary column does not have contact with the TFT substrate due to the concave portion 1413. For this reason, the same advantage as in the first embodiment is obtained. With regard to the manufacturing method according to the tenth exemplary embodiment, the number of exposure increases by one than that of the conventional art, since the substrate is etched in advance. But the subsequent processes are the same as in the conventional art.

### Eleventh Exemplary Embodiment

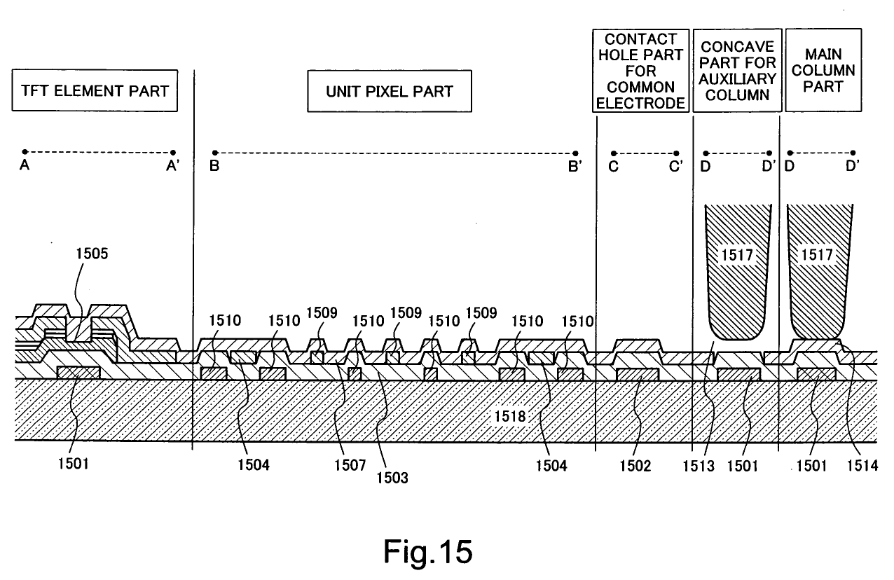

A liquid crystal display device and manufacturing method thereof according to an eleventh exemplary embodiment of the present application will be described with reference to FIG. 15. FIG. 15 is a cross sectional view showing a structure of a liquid crystal display device according to the eleventh exemplary embodiment. A plan view is the same as FIG. 13. Further, a cross sectional view indicated by DD′ is added in case of having no concave portion 1513.

It is different from the tenth exemplary embodiment that the concave portion 1513 is formed through etching not a substrate but a passivation film 1507. The other structure is the same as in the tenth exemplary embodiment. The method of forming the concave portion 1513 is the same as the method shown in FIG. 3B. According to the structure, the pixel does not include a contact hole but a terminal includes a contact hole. The contact hole of the terminal is formed through overall exposure with halftone.

Thus, in case that an external force is not applied, a column-shaped spacer 1517 as main column has contact with a TFT substrate 1518 at an unetched position 1514, through forming a height difference in the TFT substrate 1518. In contrast, the column-shaped spacer 1517 as an auxiliary column does not have contact with the TFT substrate due to the concave portion 1513. For this reason, the same effect as in the tenth exemplary embodiment is obtained. With regard to a manufacturing method according to the eleventh exemplary embodiment, the number of etchings increases by one than that of the conventional art. But, the number of exposures does not increase in comparison with the conventional art.

The previous description of embodiments is provided to enable a person skilled in the art to make and use the present application. Moreover, various modifications to these embodiments will be readily apparent to those skilled in the art, and the generic principles and specific examples defined herein may be applied to other embodiments without theuse of inventive faculty. Therefore, the present application is not intended to be limited to the embodiments described herein but is to be accorded the widest scope as defined by the limitations of the claims and equivalents.

Further, it is noted that the inventor's intent is to retain all equivalents of the claimed invention even if the claims are amended during prosecution.

This application is based on Japanese Patent Application No. JP 2006-165592 filed on Jul. 15, 2006, and including a specification, claims, drawings and summary. The disclosure of the above Japanese Patent Application is incorporated herein by reference in its entirety.

While this application has been described in Connection with certain preferred embodiments, it is to be understood that the subject matter encompassed by way of this application is not to be limited to those specific embodiments. On the contrary, it is intended for the subject matter of the application to include all alternative, modification and equivalents as can be included within the spirit and scope of the following claims.

Further, it is the inventor's intention to retain all equivalents of the claimed invention even if the claims are amended during prosecution.

What is claimed is:

1. An active matrix liquid crystal display device, comprising:
a first substrate, including:
a scan signal line;
a common signal line being parallel to the scan signal line;
an image signal line intersecting with the scan signal line and the common signal line;
a thin film transistor formed at an intersection point of the scan signal line and the image signal line;
a pixel electrode connected to one of electrodes of the thin film transistor;
a common electrode connected to the common signal line;
an insulating film sandwiched between at least one of the scan signal line, the common signal line and the image signal line, and at least one of the pixel electrode and the common electrode; and
a first concave portion formed on a surface of the first substrate on a side where the thin film transistor is formed;
a second substrate opposed to the first substrate, including:
a plurality of column-shaped spacers projecting to the first substrate and being almost equal in height to each other,
a gap being formed between the first substrate and a tip of the column-shaped spacer located at a position corresponding to the first concave portion, and the column-shaped spacer located at a different position from the position corresponding to the first concave portion reaching the first substrate; and
a liquid crystal layer sandwiched between the first substrate and the second substrate.

2. The liquid crystal display device according to claim 1, further comprising:
a second concave portion formed below the scan signal line within a region including the first concave portion.

3. The liquid crystal display device according to claim 1, further comprising:
a second concave portion formed on the insulating film within a region including the first concave portion.

4. The liquid crystal display device according to claim 1, wherein
the first concave portion is from 200 to 300 nanometers in depth.

5. The liquid crystal display device according to claim 1, wherein
the liquid crystal layer includes a liquid crystal molecule having a molecular axis rotating in a plane approximately parallel to the first substrate, the molecular axis rotating based on an electric field applied between the pixel electrode and the common electrode, the electric field being approximately parallel to a surface of the first substrate.

6. An active matrix liquid crystal display device, comprising:
a first substrate, including:
a scan signal line;
a common signal line being parallel to the scan signal line;
an image signal line intersecting with the scan signal line and the common signal line;
a thin film transistor formed at an intersection point of the scan signal line and the image signal line;
a pixel electrode connected to one of electrodes of the thin film transistor;
a common electrode connected to the common signal line;
an insulating film sandwiched between at least one of the scan signal line, the common signal line and the image signal line, and at least one of the pixel electrode and the common electrode; and
a base formed on a surface of the first substrate on a side where the thin film transistor is formed, the base being formed by leaving the insulating film;
a second substrate opposed to the first substrate, including
a plurality of column-shaped spacers projecting to the first substrate and being almost equal in height to each other,
the column-shaped spacer located at a position corresponding to the base reaching the first substrate, and
a gap being formed between the first substrate and a tip of the column-shaped spacer located at a position different from the position corresponding to the base; and
a liquid crystal layer sandwiched between the first substrate and the second substrate.

7. The liquid crystal display device according to claim 6, wherein
the base is from 200 to 300 nanometers in thickness.

8. The liquid crystal display device according to claim 6, wherein
the liquid crystal layer includes a liquid crystal molecule having a molecular axis rotating in a plane approximately parallel to the first substrate, the molecular axis rotating based on an electric field applied between the pixel electrode and the common electrode, and the electric field being approximately parallel to a surface of the first substrate.

9. A method of manufacturing an active matrix liquid crystal display device having a first substrate, a second substrate opposed to the first substrate and a liquid crystal layer sandwiched between the first substrate and the second substrate, comprising:
forming
a scan signal line on the first substrate,
a common signal line parallel to the scan signal line,
a image signal line intersecting with the scan signal line and the common signal line,
a thin film transistor formed at an intersection point of the scan signal line and the image signal line,
a pixel electrode connected to one of electrodes of the thin film transistor,
a common electrode connected to the common signal line, an insulating film between at least one of the scan signal line, the common signal line and the image signal line, and at least one of the pixel electrode and the common electrode, and
a first concave portion on a surface of the first substrate on a side where the thin film transistor is formed; and
forming
a first column-shaped spacer on the second substrate at a position corresponding to the first concave portion, the first column-shaped spacer projecting to the first substrate, and a gap being formed between the first substrate and a tip of the first column-shaped spacer, and
a second column-shaped spacer on the second substrate at a different position from the position corresponding to the first concave portion, the second column-shaped spacer projecting to the first substrate and reaching the first substrate, and a height of the second column-shaped spacer being equal to a height of the first column-shaped spacer.

10. The method for manufacturing a liquid crystal display device according to claim 9, wherein
forming the first concave portion comprises forming a second concave portion on the first substrate by etching.

11. The method for manufacturing a liquid crystal display device according to claim 9, wherein
forming the first concave portion comprises forming a second concave portion on the insulating film by etching.

12. The method for manufacturing a liquid crystal display device according to claim 9, wherein
forming the first concave portion comprises forming a contact hole to connect the pixel electrode with a source electrode of the thin film transistor, and
the insulating film is a passivation film formed between the source electrode and the pixel electrode.

13. The method of manufacturing a liquid crystal display device according to claim 9, wherein
the insulating film includes a gate insulation film formed between the common signal line and the common electrode, and a passivation film, and wherein
forming the first concave portion comprises forming a contact hole to connect the common signal line with the common electrode.

14. The method of manufacturing a liquid crystal display device according to claim 9, wherein
the liquid crystal layer includes a liquid crystal molecule having a molecular axis rotating in a plane approximately parallel to the first substrate, the molecular axis rotating based on an electric field applied between the pixel electrode and the common electrode, and the electric field being approximately parallel to a surface of the first substrate.

15. A method of manufacturing an active matrix liquid crystal display device having a first substrate, a second substrate opposed to the first substrate and a liquid crystal layer sandwiched between the first substrate and the second substrate, comprising:
forming
a scan signal line on the first substrate,
a common signal line parallel to the scan signal line,
a image signal line intersecting with the scan signal line and the common signal line,
a thin film transistor formed at an intersection point of the scan signal line and the image signal line,
a pixel electrode connected to one of electrodes of the thin film transistor,
a common electrode connected to the common signal line,
an insulating film between at least one of the scan signal line, the common signal line and the image signal line, and at least one of the pixel electrode and the common electrode, and
a base on a surface of the first substrate on a side where the thin field transistor is formed, by leaving the insulating film; and
forming
a first column-shaped spacer on the second substrate at a position corresponding to the base, and the first column-shaped spacer projecting to the first substrate and reaching the first substrate, and
a second column-shaped spacer on the second substrate at a different position from the position corresponding to the base, the second column-shaped spacer projecting to the first substrate, a gap being formed between the first substrate and a tip of the second column-shaped spacer, and a height of the second column-shaped spacer being equal to a height of the first column-shaped spacer.

16. The method of manufacturing a liquid crystal display device according to claim 15, wherein
the insulating film includes a photosensitive organic film formed between the image signal line and the pixel electrode, and wherein
forming the base comprises forming a contact hole to connect the image signal line with the pixel electrode.

17. The method of manufacturing a liquid crystal display device according to claim 16, wherein
forming the base comprises:
applying the photosensitive organic film;
exposing the photosensitive organic film within a first region with a first amount of light, and exposing the photosensitive organic film within a second region where the base is formed with a second amount of light which is less than the first amount of light, wherein the first region includes a region where the contact hole is formed and a region corresponding to the second column-shaped spacer; and
removing the photosensitive organic film within the first region, and leaving the photosensitive organic film within the second region.

18. The method of manufacturing a liquid crystal display device according to claim 15, wherein
the insulating film includes a photosensitive organic film formed between the image signal line and the common electrode which covers the image signal line, and wherein forming the base comprises forming the photosensitive organic film on the image signal line.

19. The method of manufacturing a liquid crystal display device according to claim 18, wherein forming the base comprises:
applying the photosensitive organic film;
exposing the photosensitive organic film within a first region with a first amount of light, and exposing the photosensitive organic film within a second region where the base is formed with a second amount of light which is less than the first amount of light, wherein the first region excludes the image signal line and includes a region corresponding to the second column-shaped spacer; and
removing the photosensitive organic film within the first region, and leaving the photosensitive organic film within the second region.

20. The method of manufacturing a liquid crystal display device according to claim 15, wherein
the liquid crystal layer includes a liquid crystal molecule having a molecular axis rotating in a plane approximately parallel to the first substrate, the molecular axis rotating based on an electric field applied between the pixel electrode and the common electrode, and the electric field being approximately parallel to a surface of the first substrate.
